(19) United States
(12) Patent Application Publication
(10) Pub. No.: US 2011/0076072 A1
(43) Pub. Date: Mar. 31, 2011

(54) FIXING APPARATUS AND IMAGE FORMING APPARATUS

(76) Inventors: Masaki AMEMIYA, Osaka (JP); Takashi YAMANAKA, Osaka (JP); Masaya ASAKAWA, Osaka (JP); Hirokazu NAKAMURA, Osaka (JP); Noriko INOUE, Osaka (JP)

(21) Appl. No.: 12/889,707

(22) Filed: Sep. 24, 2010

(30) Foreign Application Priority Data
Sep. 25, 2009 (JP) 2009-221195

(51) Int. Cl. G03G 15/20

(52) U.S. Cl. 399/329

(57) ABSTRACT

In one embodiment, in a fixing apparatus that is provided with a plurality of rollers including a fixing roller, and an endless fixing belt that is wound around the plurality of rollers, a regulation belt for regulating movement of the fixing belt in the axial direction is wound around at least one of both sides in the axial direction of at least one roller (for example, two rollers) among the plurality of rollers.

### CROSS-REFERENCE TO RELATED APPLICATION

This application claims priority under 35 U.S.C. §119(a) on Patent Application No. 2009-221195 filed in Japan on Sep. 25, 2009, the entire contents of which are herein incorporated by reference.

### BACKGROUND OF THE INVENTION

1. Field of the Invention

The present invention relates to a fixing apparatus, in particular a fixing apparatus that is applicable in an electrophotographic image forming apparatus such as a copying machine or a printer, and an image forming apparatus provided with the same.

2. Related Art

Fixing apparatuses that adopt a heat roller fixing method are widely used as fixing apparatuses of this type. Ordinarily, a fixing apparatus that adopts a heat roller fixing method is provided with a fixing roller and a pressure roller, which are a pair of rollers that are pressed against each other, and the pair of rollers is heated to a predetermined temperature (fixing temperature) using a heat source such as a halogen heater that is disposed in both of or one of the rollers of this pair, and thereafter a recording sheet such as recording paper on which an unfixed toner image has been formed is transported to and passes through a pressing portion (fixing nip portion) of the pair of rollers, thereby fixing the unfixed toner image onto the recording sheet with heat and pressure.

In such a fixing apparatus, there are cases of using an elastic roller that is provided with an elastic layer made of an elastic member such as a silicon rubber on the surface layer portion as a fixing roller. In particular, a fixing apparatus provided in a color image forming apparatus ordinarily uses an elastic roller as a fixing roller.

By using an elastic roller as a fixing roller, the surface of the fixing roller is elastically deformed corresponding to the unevenness of an unfixed toner image, and can thereby be in contact with the unfixed toner image so as to cover it. Accordingly, unfixed toner images (in particular, color unfixed toner images with a greater amount of toner compared to monochrome unfixed toner images) can be fixed appropriately.

Further, the motion of distortion and release of the elastic layer is easily reflected on the surface in the fixing nip portion, and thus releasability from the fixing roller can be improved (in particular, releasability from the fixing roller with respect to color toner that is easily offset compared to monochrome toner).

Furthermore, the elastic layer of the fixing roller is indented, and thus the nip shape in the fixing nip portion becomes a curved surface shape (a so-called reverse nip shape) that is curved toward a side of a recording sheet on which an unfixed toner image is formed (toward the center of rotation of the fixing roller). Accordingly, the capability for stripping the recording sheet from the fixing roller can be improved, and the recording sheet is easily stripped from the fixing roller without using, for example, a stripping means such as a stripping claw (self stripping), which enables eliminating image defects resulting from such a stripping means.

Meanwhile, along with accelerated operation of an image forming apparatus, if the process speed becomes faster, the movement speed (fixing speed) of a recording sheet that passes through the fixing nip portion in a fixing apparatus also becomes faster, and thus there are cases in which sufficient heat cannot be given to an unfixed toner image of the recording sheet in the fixing nip portion, so that fixing processing cannot be performed appropriately. Thus, in the case where the speed of the operation of an image forming apparatus is increased, it is necessary to widen the nip width of the fixing nip portion by that extent in order to appropriately perform fixing processing by giving sufficient heat to an unfixed toner image of the recording sheet in the fixing nip portion.

In the case of using an elastic roller as a fixing roller, techniques of widening the nip width of the fixing nip portion include the following: (1) a technique of thickening the elastic layer of the fixing roller; and (2) a technique of widening the diameter of the fixing roller.

With the conventional configuration in which an elastic roller serving as a fixing roller is provided with a heat source such as a halogen heater, there is the problem that the thermal conductivity of the elastic layer of the fixing roller is very low, and thus the surface temperature of the elastic layer tends not to follow the temperature change of the heat source.

For this reason, if the elastic layer is thickened as in the case of the above (1), not only does the problem of the temperature following capability of the surface of the fixing roller become more noticeable, but also the thermal conductivity of the elastic layer becomes still lower, which leads to the problem that the warm-up time for heating becomes longer by that extent, and the problem that power consumption increases by that extent. Furthermore, in the case where the diameter of the fixing roller is increased as in the above (2), the size of the fixing roller is larger, and thus thermal capacity becomes larger by that extent, which leads to the problem that the warm-up time for heating becomes longer, and the problem that power consumption increases. Such problems become noticeable particularly when the speed of the operation of an image forming apparatus is increased.

In order to solve such problems, a fixing apparatus has been proposed that adopts technology (a so-called belt fixing method) whereby the surface layer of a fixing roller is directly warmed by winding an endless fixing belt around a plurality of rollers including the fixing roller and using at least one roller other than the fixing roller among the plurality of rollers as a heat roller dedicated for heating.

The fixing apparatus that adopts this belt fixing method can heat a fixing roller more efficiently than heating from the inside the fixing roller by the fixing belt being wound around the fixing roller and a heat roller, because even without providing a heat source inside the fixing roller, it is sufficient to heat only the surface layer of the fixing belt, which is warmed by the heat roller.

For this reason, change of the surface temperature of the elastic layer of the fixing roller becomes less dependent on the thickness of the elastic layer, the thermal conductivity thereof, and the heat capacity of the fixing roller, and thus it is possible to secure a wider nip width by, for instance, providing the fixing roller with a thick elastic layer having a low degree of hardness and/or increasing the diameter of the fixing roller while suppressing a problem such as a decrease in the temperature following capability of the fixing roller and an increase in a warm-up time.

However, a belt that is wound around a plurality of rollers has a problem of easily moving in the axial direction of the rollers (wobbling and deviation) in accordance with the rotation of the rollers.

In order to solve the above problem, a configuration has been conventionally known (see JP H10-203674A) in which wobbling and deviation of a belt is suppressed by adjusting the force applied to the belt in the axial direction by tilting a steering roller, for example.

However, with the configuration disclosed in JP H10-203674A, it is necessary to provide members such as a motor and an adjustment mechanism for the control of the steering roller, which makes the structure complicated, and thus the number of components and space therefor increase, and besides cost will also increase.

Further, there is also a configuration in which movement (wobbling and deviation) of a fixing belt in the axial direction is regulated using, for example, a guide plate such as a collar or a flange for a guide function of guiding the fixing belt.

FIG. 15 is a schematic lateral view showing a conventional configuration of an example of a fixing apparatus that adopts the heat roller fixing method for regulating wobbling and deviation of a fixing belt A1 using guide plates A2 such as collars or flanges.

Further, FIGS. 16A to 16D illustrate the operation of the guide plates A2 regulating wobbling and deviation of the fixing belt A1 in the fixing apparatus shown in FIG. 15. FIGS. 16A and 16B are a plan view and a lateral view that each show a state in which wobbling and deviation of the fixing belt A1 is not occurring, and FIGS. 16C and 16D are a plan view and a lateral that each show a state in which wobbling and deviation of the fixing belt A1 is occurring.

In the fixing apparatus shown in FIG. 15, the fixing belt A1 is wound around a plurality of rollers (a fixing roller A4, a heat roller A3, and a tension roller A6 in the example shown in the figure) including the fixing roller A4. The fixing belt A1 can transfer heat from the heat roller A3 to the fixing roller A4. A pressure roller A5 is pressed against the fixing roller A4 via the fixing belt A1. This fixing apparatus receives a recording sheet on which an unfixed toner image is formed, and sandwiches and transports the recording sheet between the fixing belt A1 and the pressure roller A5. Note that the pressure roller A5 is omitted in FIGS. 16A to 16D.

The guide plates A2 such as collars or flanges are provided on both sides in the axial direction (the direction of arrow X in the figures) of at least one roller (the heat roller A3 in the examples in the figures) among a plurality of rollers (the fixing roller A4, the heat roller A3, and the tension roller A6 in the examples in the figures) around which the fixing belt A1 is wound.

In this fixing apparatus, as shown in FIGS. 16A and 16B, the fixing belt A1 is not in contact with the guide plates A2 when the fixing belt A1 is not wobbling or deviating. However, as shown in FIGS. 16C and 16D, if the fixing belt A1 moves in the axial direction X (rightward direction X1 in the example in the figure) by wobbling and deviating, the fixing belt A1 is brought into contact with the guide plate A2 and the movement thereof in the axial direction X (rightward direction X1 in the example in the figure) is regulated by the guide plate A2. At this time, since a contact area α (see a filled-in region in the figures) in the circumferential direction (the direction of arrow Y in the figures) in which the fixing belt A1 can be in contact with the guide plate A2 is comparatively small, contact pressure tends to concentrate on this contact area α. That is, the conventional fixing apparatus shown in FIGS. 15 to 16D has a structure in which edge portions A1d in the axial direction X of the fixing belt A1 tend to be damaged due to such contact pressure.

From such a viewpoint, a configuration is disclosed in which for example, a guide belt that is wound around at least two or more rollers whose axial direction differs from that of rollers around which a belt body is wound is provided separately on each of both sides in the axial direction of the belt body, thereby regulating movement (wobbling and deviation) of the belt body in the axial direction (see JP H3-76808U).

With the configuration disclosed in JP H3-76808U, a contact area in the circumferential direction where the belt body can be in contact with the guide belts can be increased, so that the pressure applied to a part of the belt body in the contact area can thereby be dispersed, and thus damage to the edge portions in the axial direction of the belt body can be suppressed. However, members around which the guide belts are wound need to be provided separately, which makes the structure complicated, and thus the number of components and space therefor increase, and besides cost will also increase.

### SUMMARY OF THE INVENTION

An object of the present invention is to provide a fixing apparatus that can control wobbling and deviation of a fixing belt and furthermore can suppress damage to the fixing belt, even with a simple structure, and an image forming apparatus provided with the same.

The present invention provides a fixing apparatus that is provided with a plurality of rollers that includes a fixing roller, an endless fixing belt that is wound around the plurality of rollers, and a regulation belt that is wound around at least one of both sides in an axial direction of at least one roller among the plurality of rollers, and regulates movement of the fixing belt in the axial direction. Further, the present invention also provides an image forming apparatus provided with such a fixing apparatus.

According to the fixing apparatus and the image forming apparatus according to the present invention, since the regulation belt is wound around at least one of both sides in the axial direction of at least one roller among the plurality of rollers, a structure in which the regulation belt is wound around can be simplified, compared to a conventional structure. Moreover, movement (wobbling and deviation) of the fixing belt in the axial direction can be regulated by the regulation belt, and furthermore a contact area in the circumferential direction in which the fixing belt can be in contact with the regulation belt can be increased. Thereby, it is possible to disperse pressure applied to a part of the fixing belt in the contact area. Accordingly, damage to an edge portion (in particular, an edge face) in the axial direction of the fixing belt can be suppressed.

In the present invention, it is preferable that the regulation belt is provided along at least a part of an unwound area of the fixing belt where the fixing belt is separated from the plurality of rollers.

In this aspect, since the regulation belt is provided along at least a part of the unwound area of the fixing belt, the contact area in which the fixing belt can be in contact with the regulation belt can be further increased, and pressure applied to a part of the fixing belt in the contact area can thereby be further dispersed, and thus damage to the edge portion (in particular, the edge face) of the fixing belt can be suppressed by that extent.

In the present invention, an aspect can be given as an example in which the regulation belt is an endless belt, and is wound around at least two rollers among the plurality of rollers.

In this aspect, since the endless regulation belt is wound around at least two rollers among the plurality of rollers, it is not necessary to separately provide members around which the regulation belt is to be wound, and the structure can be further simplified. Moreover, the contact area in which the fixing belt can be in contact with the regulation belt can be further increased between the at least two rollers. Thereby, pressure applied to a part of the fixing belt in the contact area can be further dispersed, and thus damage to the edge portion (in particular, the edge face) of the fixing belt can be suppressed by that extent.

In the present invention, the regulation belt may be configured to follow rotation of the at least one roller around which the regulation belt is wound.

In this aspect, the regulation belt follows the rotation of the roller around which the regulation belt is wound, and thereby the regulation belt and the fixing belt can move at the same speed without separately providing a driving source of the regulation belt. Accordingly, with a simple configuration, rubbing in the contact area in which the fixing belt can be in contact with the regulation belt can be suppressed, and thereby damage to the edge portion (in particular, the edge face) of the fixing belt due to that rubbing can be effectively prevented.

In the present invention, the regulation belt may be freely movable in a circumferential direction with respect to the at least one roller around which the regulation belt is wound.

In this aspect, the regulation belt is freely movable in the circumferential direction with respect to the roller around which the regulation belt is wound, and thereby the regulation belt does not follow the rotation of the roller, thus enabling reduction of the rotational load of the roller.

In the present invention, it is preferable that the regulation belt and the at least one roller around which the regulation belt is wound are engaged with each other using recessions and projections. Note that the concept of engagement using recessions and projections includes an aspect in which in the configuration where a rack is formed on the regulation belt side, and a gear is formed on the roller side around which the regulation belt is wound, the rack and the gear are engaged with each other.

In this aspect, the regulation belt and the roller around which the regulation belt is wound are engaged with each other using recessions and projections, and thereby the regulation belt and the fixing belt can be reliably moved at the same speed. Accordingly, rubbing in the contact area in which the fixing belt can be in contact with the regulation belt can be reliably suppressed, and thereby damage to the edge portion (in particular, the edge face) of the fixing belt due to that rubbing can be effectively prevented by that extent.

In the present invention, it is preferable that a guide groove in which the regulation belt is disposed is formed, over the whole circumference, in at least one roller of the at least one roller around which the regulation belt is wound.

In this aspect, the regulation belt is disposed in the guide groove that is formed over the whole circumference in at least one roller of the at least one roller around which the regulation belt is wound, and thus movement (wobbling and deviation) of the regulation belt in the axial direction can be regulated.

In the present invention, an aspect can be given as an example in which the rollers around which the fixing belt is wound have a fixing area where unfixed toner on a recording sheet is to be fixed and a non-fixing area outside the fixing area in the axial direction, the fixing belt is wound around the fixing area of the rollers around which the fixing belt is wound and an outer area outside the fixing area in the axial direction, and an insulating member is provided, over the whole circumference, on an outer edge area portion that includes at least a part of the outer area in the axial direction in the non-fixing area of at least one roller among the rollers around which the fixing belt is wound.

In this aspect, in order to lower the temperature of the edge portion of the fixing belt, the insulating member is provided, over the whole circumference, on the outer edge area portion of at least one roller of the rollers around which the fixing belt is wound, and thereby it is possible to suppress heat that is transferred to the edge portion of the fixing belt. Accordingly, the temperature of the edge portion of the fixing belt can be lowered, and ultimately it is possible to suppress damage to the edge portion (in particular, the edge face) of the fixing belt that may be caused when the fixing belt wobbles and deviates.

In the present invention, it is preferable that a protruding portion that protrudes toward the fixing belt is provided on the regulation belt.

In this aspect, the regulation belt is provided with the protruding portion, and thus it is possible to prevent the fixing belt from easily climbing over the regulation belt, and/or it is possible to prevent the fixing belt from easily curling up.

More preferably, an aspect can be given as an example in which at least a part of an edge face of the regulation belt in a belt thickness direction has a shape inclined toward the fixing belt, the edge face being opposed to the fixing belt.

In this aspect, at least a part of the edge face of the regulation belt in the belt thickness direction has a shape inclined toward the fixing belt, the edge face being opposed to the fixing belt, and thereby it is possible to further prevent the fixing belt from easily climbing over the regulation belt, and also the edge portion of the fixing belt that reaches the edge face of the regulation belt can be caused to slide toward the roller and return toward the center in the axial direction, by the inclined edge face of the regulation belt.

In the present invention, it is preferable that a part of an edge face of the regulation belt in a circumferential direction is a contact area where the fixing belt can be in contact with the regulation belt while the fixing belt rotates, the edge face being opposed to the fixing belt, and the regulation belt is wound so that the contact area is larger than the other area.

In this aspect, the direction of the edge face of the regulation belt conforms to the direction in which the contact area is increased, and thereby, the contact area in which the fixing belt can be in contact with the regulation belt can be reliably increased, and pressure applied to a part of the fixing belt in the contact area can be more stably dispersed by that extent.

In the present invention, an aspect can be given as an example in which among the plurality of rollers, at least one of the rollers other than the fixing roller is a heat roller, and the regulation belt is wound around at least the heat roller.

In this aspect, the regulation belt is wound around at least the heat roller (generally, the heat roller whose surface has a friction coefficient smaller than the friction coefficient of the surface of the fixing roller), and thereby damage to the edge portion (in particular, the edge face) of the fixing belt can be suppressed while reliably regulating wobbling and deviation of the fixing belt on the heat roller, on which the fixing belt tends to easily move in the axial direction.

As described above, according to a fixing apparatus and an image forming apparatus provided with the same according to the present invention, since the regulation belt is wound around at least one of both sides in the axial direction of at least one roller among the plurality of rollers, wobbling and deviation of the fixing belt can be regulated, and furthermore damage to the fixing belt can be suppressed, even with a simple structure.

### BRIEF DESCRIPTION OF THE DRAWINGS

FIG. 1 is a lateral view showing a schematic configuration of an image forming apparatus provided with a fixing apparatus according to an embodiment of the present invention.

FIG. 2 is a schematic configuration diagram showing a fixing apparatus that adopts a belt fixing method according to the embodiments of the present invention, viewed from the rear face.

FIG. 3 is an enlarged detail view showing a main part of the fixing apparatus shown in FIG. 2.

FIG. 4 is a schematic lateral view showing a state in which regulation belts are provided in the fixing apparatus shown in FIG. 3.

FIGS. 5A and 5B are schematic diagrams showing the state in which the regulation belts are provided in the fixing apparatus shown in FIG. 3, where FIG. 5A is a plan view thereof, and FIG. 5B is a lateral view thereof.

FIGS. 6A and 6B are diagrams illustrating an operation of the regulation belt regulating wobbling and deviation of a fixing belt in a fixing apparatus according to a first embodiment, and FIGS. 6A and 6B are a plan view and a lateral view that each show a state where wobbling and deviation of the fixing belt is occurring.

FIGS. 7A to 7C are lateral views showing other examples in which the regulation belts are wound around at least one roller among a fixing roller, a heat roller and a tension roller in the first embodiment, where FIG. 7A is a diagram showing a state in which the regulation belts are wound around the fixing roller and the tension roller, FIG. 7B is a diagram showing a state in which the regulation belts are wound around the fixing roller and the heat roller, and FIG. 7C is a diagram showing a state in which the regulation belts are wound around the fixing roller, the heat roller, and the tension roller.

FIG. 8 is a lateral view showing a state in which the regulation belts are wound around in the case where the fixing belt is wound around the fixing roller and the heat roller, in the first embodiment.

FIG. 9 is a lateral view illustrating a fixing apparatus according to a second embodiment.

FIGS. 10A and 10B are cross-sectional views illustrating a fixing apparatus according to a third embodiment, where FIG. 10A is a diagram showing a guide groove provided in a heat roller, and FIG. 10B is a diagram showing a guide groove provided in a tension roller.

FIGS. 11A and 11B are cross-sectional views illustrating a fixing apparatus according to a fourth embodiment, where FIG. 11A is a diagram showing a sliding bearing with which a heat roller is provided, and FIG. 11B is a diagram showing a sliding bearing with which a tension roller is provided.

FIG. 12 is a cross-sectional view illustrating a fixing apparatus according to a fifth embodiment, and showing an insulating member provided on a heat roller.

FIG. 13 is a cross-sectional view illustrating a fixing apparatus according to a sixth embodiment.

FIGS. 14A and 14B are cross-sectional views illustrating a fixing apparatus according to a seventh embodiment, where FIG. 14A is a diagram showing a regulation belt wound around a heat roller, and FIG. 14B is a diagram showing the regulation belt wound around a tension roller.

FIG. 15 is a schematic lateral view showing the conventional configuration of an example of a fixing apparatus that adopts a heat roller fixing method according to which wobbling and deviation of a fixing belt is regulated using a guide plate such as a collar or a flange.

FIGS. 16A to 16D are diagrams illustrating an operation of the guide plate regulating wobbling and deviation of the fixing belt in the fixing apparatus shown in FIG. 15, where FIGS. 16A and 16B are a plan view and a lateral view that each show a state in which wobbling and deviation of the fixing belt is not occurring, and FIGS. 16C and 16D are a plan view and a lateral view that each show a state in which wobbling and deviation of the fixing belt is occurring.

### DESCRIPTION OF PREFERRED EMBODIMENTS

Hereinafter, embodiments according to the present invention are described with reference to the drawings. Note that the embodiments below are examples of embodiments of the present invention, and are not intended to limit the technical scope of the present invention.

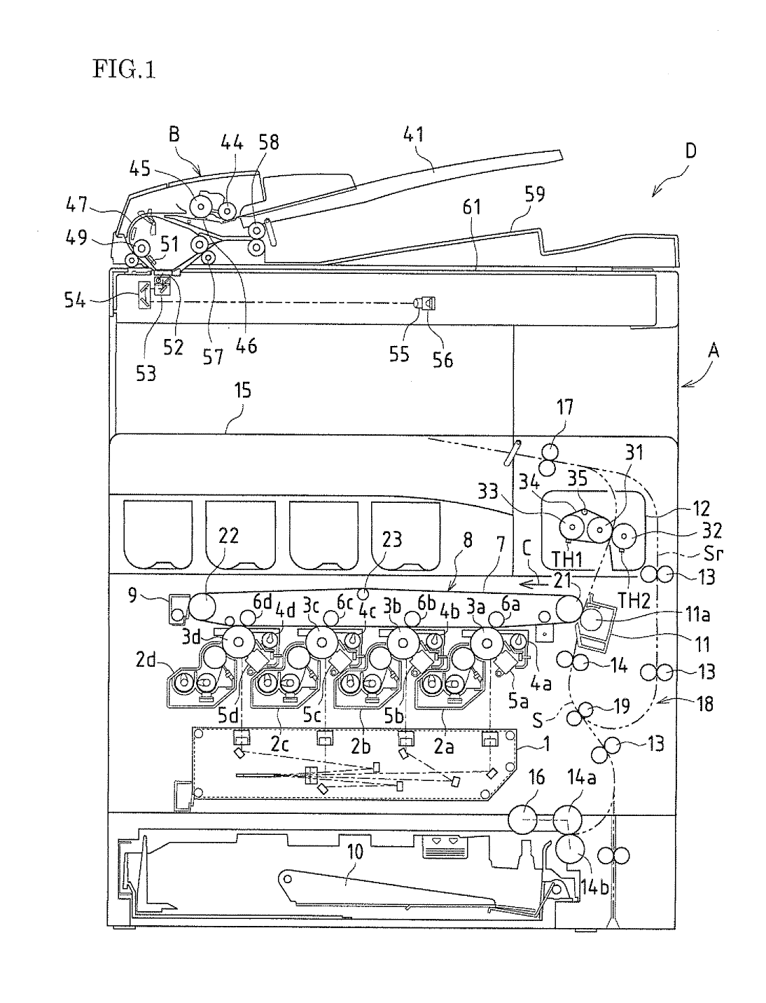

FIG. 1 is a lateral view showing a schematic configuration of an image forming apparatus D provided with a fixing apparatus according to an embodiment of the present invention.

The image forming apparatus D shown in FIG. 1 is provided with an original reading apparatus B that reads an image of an original, and an apparatus main body A that records and forms an image of an original read by the original reading apparatus B or an image received from the outside in color or monochrome on a recording sheet such as paper.

In the original reading apparatus B, when an original is set on an original setting tray 41, a pickup roller 44 rotates while pressing against the front face of the original, and the original is pulled out from the original setting tray 41 and passed between a separation roller 45 and a separation pad 46 so as to be separated sheet-by-sheet, and then transported to a transport path 47.

On the transport path 47, a leading edge of the original abuts against registration rollers 49, and becomes aligned parallel to the registration rollers 49. After that, the original is transported by the registration rollers 49, and passes between a reading guide 51 and a reading glass 52. At this time, the front face of the original is irradiated with light from a light source of a first scanning unit 53 via the reading glass 52, and the light reflected therefrom enters the first scanning unit 53 through the reading glass 52, and this reflected light is reflected by mirrors of the first scanning unit 53 and a second scanning unit 54 to be guided to an imaging lens 55. Then, the image of the front face of the original is formed on a CCD (charge coupled device) 56 by the imaging lens 55. The CCD 56 reads the image of the front face of the original, and outputs image data that indicates the image of the front face of the original. Furthermore, the original is transported by transport rollers 57, and discharged onto a discharge tray 59 via discharge rollers 58.

Further, the original reading apparatus B can read an original placed on an original stage glass 61. The registration rollers 49, the reading guide 51, and the discharge tray 59, and the like, and members above them serve as an integrated cover body that is pivotably supported to be openable and closable about an axis in the sub-scanning direction at the rear face side of the original reading apparatus B. When this upper cover body is opened, the original stage glass 61 is uncovered, and an original can be placed on the original stage glass 61. When the cover body is closed after an original is placed, while the first and second scanning units 53 and 54 are moved in the sub-scanning direction, the front face of the original on the original stage glass 61 is exposed by the first scanning unit 53, and reflected light from the front face of the original is guided to the imaging lens 55 by the first and second scanning units 53 and 54. Then, an image of the front face of the original is formed on the CCD 56 by the imaging lens 55. At this time, the first and second scanning units 53 and 54 are moved while maintaining a predetermined speed relationship therebetween. That is, the positional relationship between the first and second scanning units 53 and 54 is constantly maintained such that there is no change in the length of the optical path of the reflected light from the front face of the original to the CCD 56 via the first and second scanning units 53 and 54 and the imaging lens 55. Thus, focus of the image of the front face of the original is always accurately maintained on the CCD 56.

The entire image of the original read in this way is transmitted to and received by the apparatus main body A of the image forming apparatus D as image data, and is recorded on a recording sheet in the apparatus main body A.

Meanwhile, the apparatus main body A of the image forming apparatus D is provided with an exposing apparatus 1, development apparatuses 2 (2a, 2b, 2c, 2d), photosensitive drums 3 (3a, 3b, 3c, 3d) that operate as image carriers, charging units 5 (5a, 5b, 5c, 5d), cleaner apparatuses 4 (4a, 4b, 4c, 4d), an intermediate transfer belt apparatus 8 including intermediate transfer rollers 6 (6a, 6b, 6c, 6d) that operates as a transfer portion, a fixing apparatus 12, a sheet transport apparatus 18, a paper feed tray 10 that operates as a paper feed portion, and a discharge tray 15 that operates as a discharge portion.

Image data handled in the apparatus main body A of the image forming apparatus D corresponds to a color image using black (K), cyan (C), magenta (M), and yellow (Y), or corresponds to a monochrome image using a single color (for example, black). Accordingly, four sets each of the development apparatuses 2 (2a, 2b, 2c, 2d), the photosensitive drums 3 (3a, 3b, 3c, 3d), the charging units 5 (5a, 5b, 5c, 5d), the cleaner apparatuses 4 (4a, 4b, 4c, 4d), and the intermediate transfer rollers 6 (6a, 6b, 6c, 6d) are provided in order to form four types of images corresponding to the respective colors, thus constituting four image stations. Among suffix signs a to d of the reference numerals, suffix sign a corresponds to black, suffix sign b corresponds to cyan, suffix sign c corresponds to magenta, and suffix sign d corresponds to yellow. Hereinafter, a description is given with suffix signs a to d being omitted.

The photosensitive drums 3 are disposed substantially in the center in the vertical direction of the apparatus main body A.

The charging unit 5 is a charging means for uniformly charging the surface of the photosensitive drum 3 to a predetermined potential, and other than a contact-roller-type charging unit or a contact-brush-type charging unit, a charging-type charging unit is used.

Here, the exposing apparatus 1 is a laser scanning unit (LSU) provided with a laser diode and a reflecting mirror, and exposes the charged surface of the photosensitive drum 3 according to image data to form an electrostatic latent image that corresponds to the image data on that surface.

The development apparatuses 2 develop electrostatic latent images formed on the photosensitive drums 3 using toner (K, C, M, Y). The cleaner apparatus 4 removes and collects toner remaining on the surface of the photosensitive drum 3 after development and image transfer.

The intermediate transfer belt apparatus 8 disposed above the photosensitive drums 3 is provided with an intermediate transfer belt 7, an intermediate transfer belt drive roller 21, an idler roller 22, a tension roller 23, and an intermediate transfer belt cleaning apparatus 9, in addition to the intermediate transfer rollers 6.

The intermediate transfer belt 7 is stretched across and supported by roller members such as the intermediate transfer belt drive roller 21, the intermediate transfer roller 6, the idler roller 22, and the tension roller 23, which allow the intermediate transfer belt 7 to revolve in a predetermined sheet transport direction (the direction of arrow C in FIG. 1).

The intermediate transfer rollers 6 are rotatably supported inside the intermediate transfer belt 7, and pressed against the photosensitive drums 3 via the intermediate transfer belt 7.

The intermediate transfer belt 7 is provided so as to be in contact with the photosensitive drums 3. Toner images on the surface of the photosensitive drums 3 are sequentially transferred to and superimposed on the intermediate transfer belt 7, thereby forming a color toner image (toner images of the respective colors). Here, this intermediate transfer belt 7 is formed as an endless belt, using a film having a thickness of approximately 100 μm to 150 μm.

Toner images are transferred from the photosensitive drums 3 to the intermediate transfer belt 7 by the intermediate transfer rollers 6, which are pressed against the inner side (back surface) of the intermediate transfer belt 7. In order to transfer the toner images, a high voltage transfer bias (high voltage with opposite polarity (+) to the charge polarity (−) of the toner, for example) is applied to the intermediate transfer rollers 6. The intermediate transfer rollers 6 use a metal (stainless steel, for example) shaft with a diameter of 8 to 10 mm as a base, and the surface of this shaft is covered with conductive elastic material (such as EPDM or urethane foam, for example). With this conductive elastic material, it is possible to uniformly apply a high voltage to a recording sheet.

The apparatus main body A of the image forming apparatus D is further provided with a secondary transfer apparatus 11 that includes a transfer roller 11a and that operates as a transfer portion. The transfer roller 11a is in contact with the outer side of the intermediate transfer belt 7.

As described above, the toner images on the surface of the photosensitive drums 3 are layered on the intermediate transfer belt 7 to become a color toner image indicated by image data. The toner images of the respective colors that have been layered in this way are transported with the intermediate transfer belt 7, and transferred onto the recording sheet by the secondary transfer apparatus 11.

The intermediate transfer belt 7 and the transfer roller 11a of the secondary transfer apparatus 11 are pressed against each other to form a transfer nip region. Further, a voltage (high voltage with opposite polarity (+) to the charge polarity (−) of the toner, for example) for transferring toner images of the respective colors on the intermediate transfer belt 7 to a recording sheet is applied to the transfer roller 11a of the secondary transfer apparatus 11. Furthermore, in order to constantly obtain the transfer nip region, either one of the transfer roller 11a of the secondary transfer apparatus 11 or the intermediate transfer belt drive roller 21 is made of a hard material (metal or the like), and the other roller is made of a soft material, such as an elastic roller (elastic rubber roller, foam resin roller, or the like).

Toner may remain on the intermediate transfer belt 7 due to the secondary transfer apparatus 11 not completely transferring the toner image on the intermediate transfer belt 7 onto the recording sheet, and this remaining toner causes toner color mixing to occur in a subsequent process. Therefore, such remaining toner is removed and collected by the intermediate transfer belt cleaning apparatus 9. The intermediate transfer belt cleaning apparatus 9 is provided with, for example, a cleaning blade that is in contact with the intermediate transfer belt 7 as a cleaning member, and remaining toner can be removed and collected by this cleaning blade. The idler roller 22 supports the intermediate transfer belt 7 from the inner side (back side), and the cleaning blade is in contact with the intermediate transfer belt 7 so as to apply pressure to the idler roller 22 from outside.

The paper feed tray 10 is a tray for storing recording sheets, and is provided in the lower part of an image forming portion of the apparatus main body A. Further, the discharge tray 15 provided in the upper part of the image forming portion is a tray on which a printed recording sheet is placed facedown.

Further, the apparatus main body A is provided with the sheet transport apparatus 18 for feeding a recording sheet on the paper feed tray 10 to the discharge tray 15 via the secondary transfer apparatus 11 and the fixing apparatus 12. This sheet transport apparatus 18 has an S-shaped sheet transport path S, and transport members such as a pickup roller 16, a separation roller 14a, a separation roller 14b, transport rollers 13, pre-registration rollers 19, registration rollers 14, the fixing apparatus 12, and discharge rollers 17 are disposed along the sheet transport path S. This fixing apparatus 12 will be described in detail later.

The pickup roller 16 is a draw-in roller that is provided at an edge portion on a downstream side in the sheet transport direction of the paper feed tray 10, and supplies recording sheets sheet-by-sheet from the paper feed tray 10 to the sheet transport path S. The separation roller 14a transports recording sheets to the sheet transport path S while causing the recording sheets to pass between the separation rollers 14a and 14b so as to separate them sheet-by-sheet. The transport rollers 13 and the pre-registration rollers 19 are small rollers for promoting and assisting transportation of recording sheets. The transport rollers 13 are provided at a plurality of positions along the sheet transport path S.

The registration rollers 14 align the leading edge of a transported recording sheet by the recording sheet butting thereagainst in a stopped state, and transport the recording sheet in a timely manner in synchronization with a toner image formed on the intermediate transfer belt 7 such that the toner image on the intermediate transfer belt 7 is transferred onto the recording sheet in the transfer nip region between the intermediate transfer belt 7 and the secondary transfer apparatus 11. For example, the registration rollers 14 transport a recording sheet such that a toner image on the intermediate transfer belt 7 comes to a position of the recording sheet at which an image is to be formed, in the transfer nip region between the intermediate transfer belt 7 and the secondary transfer apparatus 11.

The fixing apparatus 12 is assumed to be a fixing apparatus that adopts a belt fixing method, and a fixing belt 34 is wound around a plurality of rollers (here, a fixing roller 31, a heat roller 33, and a tension roller 35) including the fixing roller 31. The fixing belt 34 can transfer heat from the heat roller 33 to the fixing roller 31. The fixing roller 31 is pressed by a pressure roller 32 via the fixing belt 34. Further, the temperatures of the fixing belt 34 and the pressure roller 32 are respectively controlled by temperature detection apparatuses (for example, thermistors) TH1 and TH2 so as to be a predetermined fixing belt temperature and a predetermined pressure roller temperature. The fixing apparatus 12 receives a recording sheet on which an unfixed toner image is formed, and sandwiches and transports the recording sheet between the fixing belt 34 and the pressure roller 32. This fixing apparatus 12 will be described in detail later.

The recording sheet on which toner images of the respective colors have been fixed is discharged onto the discharge tray 15 by the discharge rollers 17.

Note that it is also possible to form a monochrome image using at least one of the four image forming stations, and transfer the monochrome image to the intermediate transfer belt 7 of the intermediate transfer belt apparatus 8. Similar to a color image, such a monochrome image is also transferred from the intermediate transfer belt 7 to a recording sheet, and fixed onto the recording sheet.

Further, when image formation is performed on not only the front face of the recording sheet, but on both faces, an image on the front face of the recording sheet is fixed by the fixing apparatus 12, and thereafter the discharge rollers 17 are stopped and then rotated in reverse while transporting the recording sheet by the discharge rollers 17 on the sheet transport path S, thereby causing the recording sheet to pass through a reverse path Sr. The front and back of the recording paper are reversed, and thereafter the recording sheet is again led to the registration rollers 14. Similar to the case of the front face of the recording sheet, an image is recorded and fixed on the back face of the recording sheet, and the recording sheet is discharged onto the discharge tray 15.

Fixing Apparatus

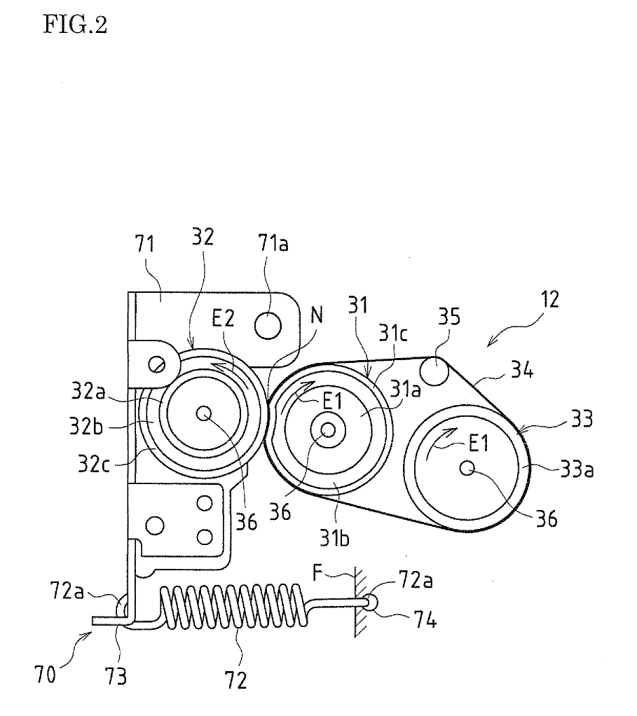

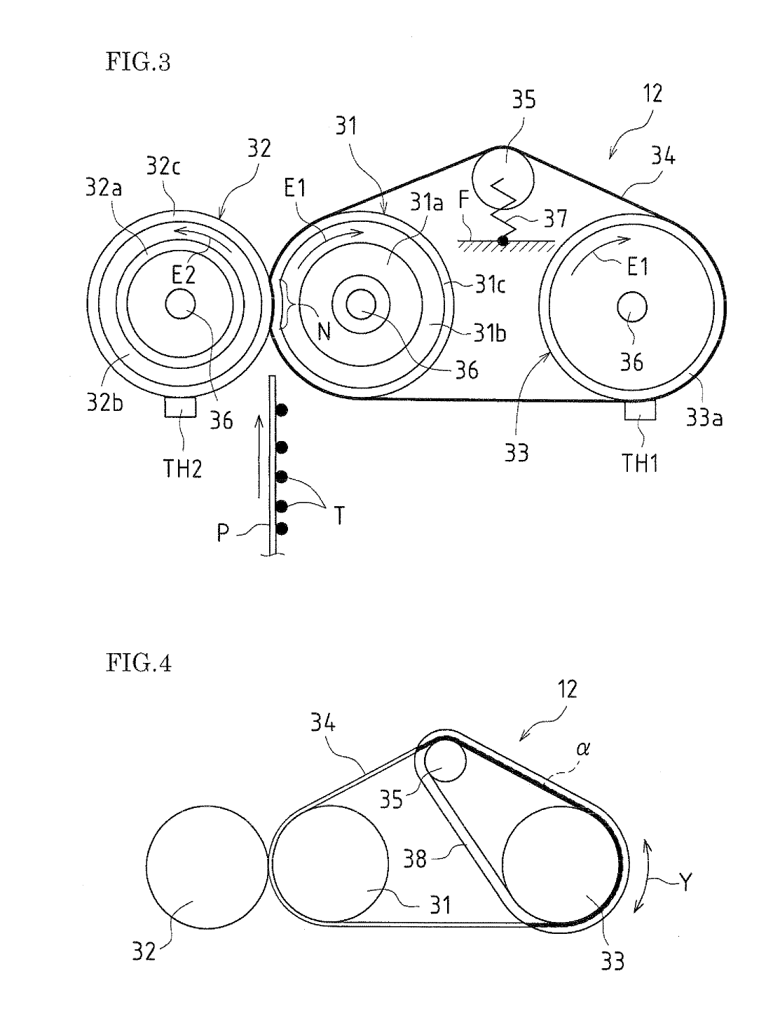

FIG. 2 is a schematic configuration diagram showing the fixing apparatus 12 that adopts the belt fixing method according to the present embodiment, viewed from the rear face. Further, FIG. 3 is an enlarged detail view showing a main part of the fixing apparatus 12 shown in FIG. 2.

As shown in FIGS. 2 and 3, the fixing apparatus 12 is provided with the plurality of rollers 31, 33, and 35 (here, three) including the fixing roller, and the endless fixing belt 34 that is wound around the plurality of rollers 31, 33, and 35. At least one of the rollers other than the fixing roller among the plurality of rollers 31, 33, and 35 is assumed to be a heat roller.

The fixing apparatus 12 is further provided with the pressure roller 32, and a fixing nip region (fixing nip portion) N is formed between the fixing belt 34 and the pressure roller 32 in a state where the fixing roller 31 and the pressure roller 32 are pressed against each other with the fixing belt 34 therebetween.

Here, a fixing roller means a roller that is opposed to unfixed toner on a recording sheet in a state where a fixing belt is interposed therebetween. Specifically, a fixing roller means a roller that is opposed to unfixed toner on a recording sheet between a fixing belt and a pressure roller and presses the unfixed toner with the pressure roller, in a state where the fixing belt is interposed between the fixing roller and the pressure roller. Further, a heat roller means a roller that is other than the fixing roller, and is heated by a heat source such as a halogen heater (specifically, a roller provided with a heat source). Note that although there are cases where a fixing roller is heated by a heat source, the fixing roller in such cases is not included in the concept of the heat roller described in this specification.

Here, the roller 31 is assumed to be a fixing roller that is opposed to unfixed toner T on a recording sheet P via the fixing belt 34, and the roller 33 is assumed to be a heat roller for heating the fixing belt 34. Further, the roller 35 is assumed to be a tension roller for applying tension (tensile force) of the fixing belt 34.

In the fixing apparatus 12, in the state of being installed in the apparatus main body A of the image forming apparatus D, a drive mechanism (not shown) such as a gear on the apparatus main body A side meshes with a gear provided on the rotating shaft of the fixing roller 31, and rotational driving force from the drive mechanism on the apparatus main body A side is transferred to the rotating shaft of the fixing roller 31 via the gear, and thereby the fixing roller 31 is driven to rotate in a predetermined rotation direction (the direction of arrow E1 in the figures), In accordance with the rotation of the fixing roller 31, the heat roller 33 rotates in the same direction E1 as that of the fixing roller 31, and thereby the fixing belt 34 revolves. Furthermore, the pressure roller 32 is idly rotated in the direction (the direction of arrow E2 in the figures) that is opposite to the rotation direction E1 of the fixing roller 31. At this time, a control portion (not shown) controls heat sources 36 so as to operate (be energized), such that the temperatures of the fixing belt 34 and the pressure roller 32 become a predetermined fixing belt temperature and a predetermined pressure roller temperature based on the detection results of the temperature detection apparatuses TH1 and TH2. The recording sheet P is sandwiched and transported between the fixing belt 34 and the pressure roller 32, and heat and pressure is applied thereto in the fixing nip region N. Thereby, the unfixed toner T on the recording sheet P is fused, mixed, and pressed so as to be thermally fixed.

Specifically, the fixing roller 31 is assumed to be a roller having a three-layer structure in which an elastic layer 31b is provided on an outer surface of a core metal 31a and a releasing layer 31c is formed on an outer surface of the elastic layer 31b. For example, the material such as a metal such as iron, stainless steel, aluminum, or copper, or an alloy of these can be used for the core metal 31a. Furthermore, a silicon rubber can be used for the elastic layer 31b, and a fluorocarbon resin such as PFA (tetrafluoroethylene-perfluoroalkylvinylether copolymer) or PTFE (polytetrafluoroethylene) can be used for the releasing layer 31c. The heat source (here, a halogen heater lamp) 36 for heating the fixing roller 31 is provided inside the fixing roller 31 (here, inside the core metal 31a). Thereby, the fixing roller 31 is heated by the heat source 36, and the heat of the fixing roller 31 is transferred via the fixing belt 34 to the recording sheet P and the unfixed toner T on the recording sheet P.

Further, the heat roller 33 is constituted by a core metal 33a, and the heat source (here, a halogen heater lamp) 36 for heating the heat roller 33 is also provided inside the heat roller 33 (here, inside the core metal 33a). Accordingly, the heat roller 33 is heated by the heat source 36, and the heat of the heat roller 33 is transferred to the fixing belt 34, and furthermore transferred to the surface of the fixing roller 31 via the fixing belt 34, thereby supplementing the amount of heat of the fixing roller 31.

Similar to the fixing roller 31, the pressure roller 32 is assumed to be a roller that has a three-layer structure in which a core metal 32a made of a metal such as iron, stainless steel, aluminum, or copper, or an alloy of these, an elastic layer 32b made of a silicon rubber or the like provided on the surface of the core metal 32a, and further still a releasing layer 32c made of PFA, PTFE, or the like on the elastic layer. The heat source (here, a halogen heater lamp) 36 for heating the pressure roller 32 is also provided inside the pressure roller 32 (here, inside the core metal 32a). Thereby, the pressure roller 32 is heated by the heat source 36, and the heat of the pressure roller 32 is transferred to the fixing belt 34 and the recording sheet P.

The tension roller 35 is disposed on the inner side of the fixing belt 34, and is assumed to be freely movable outwardly and inwardly so as to be capable of applying tension to the fixing belt 34. The tension roller 35 is biased toward the outside by a biasing member (for example, a coil spring) 37 whose one end is supported by a body frame F and other end is connected to the tension roller 35.

Note that the fixing roller 31 and the pressure roller 32 are not necessarily provided with the heat sources 36. Further, the tension roller 35 may be disposed on the outside of the fixing belt 34, and biased toward the inside by the biasing member. Further, the tension roller 35 may be provided with the heat source 36. If the fixing belt 34 is further wound around other rollers, at least one of the other rollers may be provided with the heat source 36.

In the present embodiment, the fixing apparatus 12 further has a pressing portion 70. The pressing portion 70 includes a pressure frame 71 and a biasing member (here, a coil spring) 72.

The pressure frame 71 axially supports the pressure roller 32, and is assumed to allow the pressure roller 32 to be swingable in a direction of applying pressure and in a direction of cancelling pressure, with respect to the fixing roller 31. Specifically, the pressure frame 71 supports the rotating shaft of the pressure roller 32 via bearings (not shown) so as to be freely rotatable about the axis, and is furthermore supported so as to be freely swingable, with respect to the main body of the fixing apparatus 12, about a pivotal support shaft 71a (more specifically, a shaft 71a that is supported by the body frame (not shown) of the fixing apparatus 12) that is in the direction of the axis of the pressure roller 32 (hereinafter, referred to as an axial direction). The fixing roller 31 is axially supported so as to be freely rotatable about the axis by the body frame (not shown) of the fixing apparatus 12, and is rotated by the rotational driving force from the drive mechanism on the apparatus main body A side being transferred thereto via the gear, which is as described, above.

The pressure frame 71 is biased by the coil spring 72 in the direction in which the pressure roller 32 is pressed against the fixing roller 31. Specifically, hooks 72a on both ends of the coil spring 72 are respectively hooked around a latching portion 74 of the body frame F and a latching portion 73 that is positioned outwardly in the radial direction with the shaft 71a of the pressure frame 71 as the center, and the latching portion 73 of the pressure frame 71 is pulled by the coil spring 72 toward the latching portion 74 of the body frame F. Thereby, the pressure frame 71 is biased toward the fixing roller 31 with the shaft 71a as the center, and the pressure roller 32 is pressed against the fixing roller 31.

In the present embodiment, the elastic layer 31b of the fixing roller 31 is indented with the releasing layer 31c, and thus the nip shape of the fixing nip region N becomes a curved surface shape (a so-called reverse nip shape) that is curved toward the side of the recording sheet P on which the unfixed toner T exists (toward the center of rotation of the fixing roller 31). Accordingly, the capability for stripping the recording sheet P from the fixing roller 31 can be improved, and the recording sheet P is easily stripped from the fixing roller 31 without using, for example, a stripping means such as a stripping claw, which enables eliminating image defects resulting from such a stripping means.

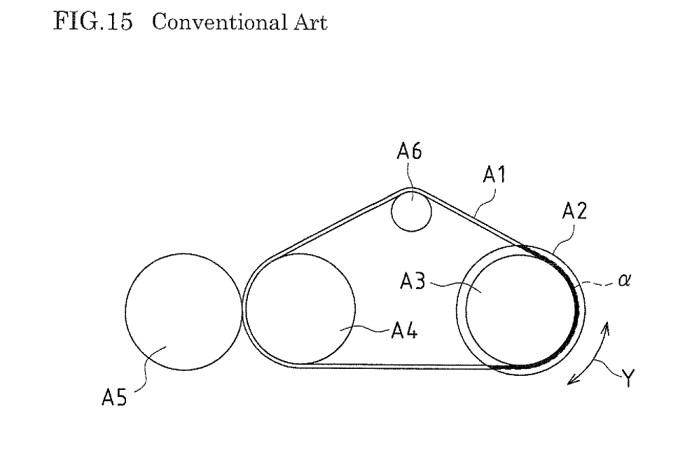

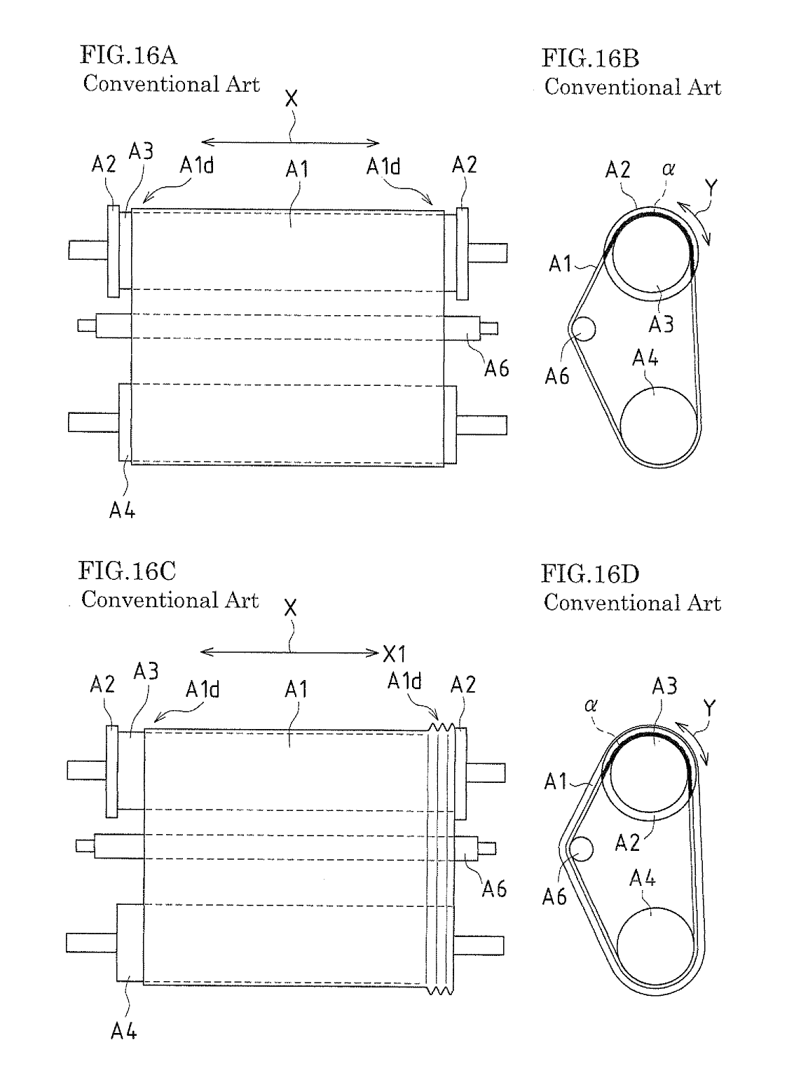

The fixing belt 34 that is wound around a plurality of rollers (here, the fixing roller 31, the heat roller 33, and the tension roller 35) easily moves (wobbles and deviates) in the axial direction of the rollers 31, 33, and 35, in accordance with the rotation of the rollers 31, 33 and 35. As shown in FIGS. 15 to 16D, in a conventional fixing apparatus that is provided with the guide plates A2 such as collars or flanges, as already described above, since the contact area α (see a filled-in region in the figures) in the circumferential direction in which the fixing belt A1 can be in contact with the guide plate A2 is comparatively small, contact pressure tends to concentrate on this contact area α, and thus such a conventional fixing apparatus has a configuration in which the edge portion A1d in the axial direction X of the fixing belt A1 tends to be damaged due to such contact pressure.

### Description of Distinguishing Features of the Present Invention

In this regard, the fixing apparatus 12 according to the present embodiment is provided with regulation belts 38, 381, or 382 (omitted in FIGS. 1 to 3, and see FIGS. 4 to 14B described later) for regulating movement of the fixing belt 34 in the axial direction of the rollers 31, 33, and 35.

### First Embodiment

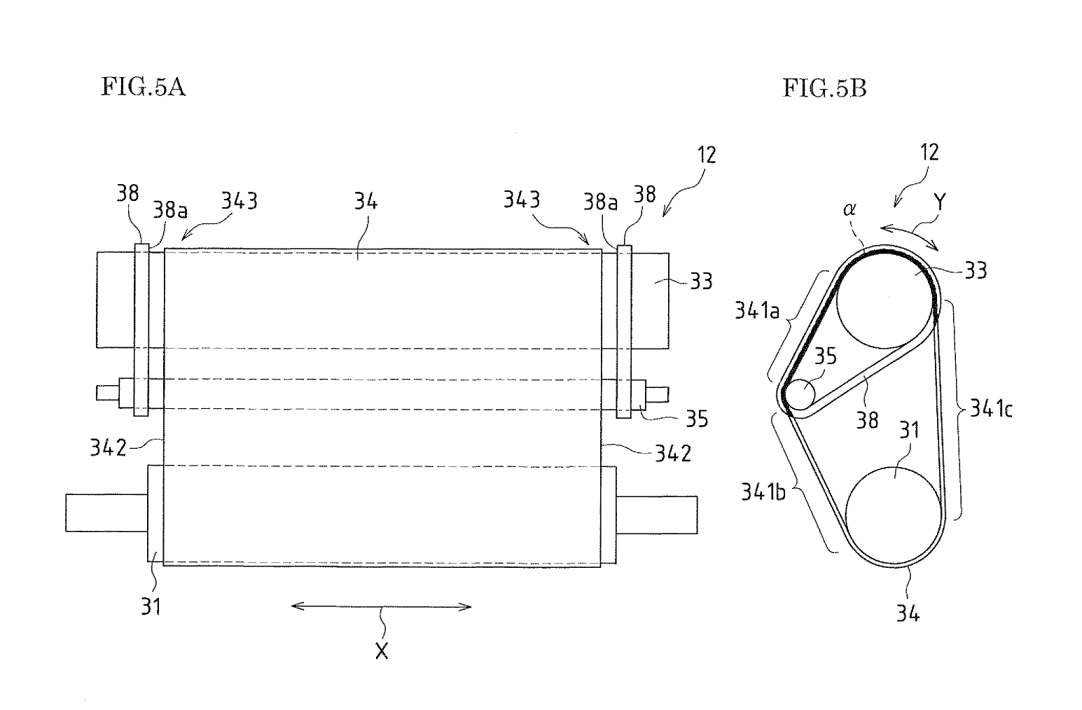

FIGS. 4, 5A, and 5B are schematic diagrams showing a state where regulation belts 38 are provided in the fixing apparatus 12 shown in FIG. 3. FIGS. 4 and 5B show a lateral view thereof, and FIG. 5A shows a plan view thereof. Note that the pressure roller 32 is omitted in FIGS. 5A and 5B.

As shown in FIGS. 4, 5A, and 5B, the regulation belts 38 are wound around at least one (here, both sides) of both sides in the axial direction (the direction X in FIG. 5A) of at least one roller (33, 35) among the fixing roller 31, the heat roller 33, and the tension roller 35.

Specifically, the regulation belts 38 are wound around at least one roller (33, 35) among the fixing roller 31, the heat roller 33, and the tension roller 35, along at least a part (here, a first unwound area 341a) of unwound areas (here, first to third unwound areas 341a, 341b and 341c) where the fixing belt 34 is separated from the fixing roller 31, the heat roller 33, and the tension roller 35, and furthermore in the circumferential direction (the winding direction, the direction of arrow Y in the figures) (an aligned state, in other words, an overlapped state viewed from the side face).

Note that with regard to the fixing belt 34, the first unwound area 341a is an unwound area between the heat roller 33 and the tension roller 35, the second unwound area 341b is an unwound area between the fixing roller 31 and the tension roller 35, and the third unwound area 341c is an unwound area between the fixing roller 31 and the heat roller 33.

More specifically, the regulation belts 38 are assumed to be endless belts and are wound around at least two rollers (here, the heat roller 33 and the tension roller 35) among the fixing roller 31, the heat roller 33, and the tension roller 35.

Here, the fixing belt 34 has a three-layer structure, in which the first layer is formed using a polyimide resin, and the second layer is formed using a silicon rubber. Fluororesin coating such as PFA is applied to the surface layer of the fixing belt 34. The material of the fixing belt 34 is not limited to the above material. Further, a PFA tube or the like may be used for the surface layer of the fixing belt 34.

The thickness of each of the regulation belts 38 is greater than the thickness of the fixing belt 34. As the regulation belts 38, it is preferable to use a material whose surface is smooth, and that has favorable sliding properties, and is highly resistant to heat. The material that can be used for the regulation belts 38 is not limited thereto, and polyacetal or the like can be used as the material.

In the first embodiment, the regulation belts 38 are configured to revolve following the rotation of the rollers 33 and 35 around which the regulation belts 38 are wound. Further, the direction of each of edge faces 38a of the regulation belts 38 conforms to the direction in which the contact area α is increased. Here, the direction of each of the edge faces 38a of the regulation belts 38 and the direction of each of edge faces 342 of the fixing belt 34 that are opposed to the edge faces 38a of the regulation belts 38 are assumed to be parallel or substantially parallel to each other.

There are many cases where the surface of a heat roller is ordinarily formed with material whose friction coefficient is smaller than that of the material of the surface of a fixing roller, thereby allowing the fixing belt to easily slip on the heat roller having a smaller friction coefficient, and thus the force applied to the fixing belt in the axial direction easily escapes. On the other hand, there are many cases where the surface of the fixing roller is ordinarily formed with material (for example, an elastic body such as sponge-like porous material or rubber material) having a greater friction coefficient than that of the material of the surface of the heat roller, thereby preventing the fixing belt from easily slipping on the fixing roller having a greater friction coefficient, and thus the force applied to the fixing belt in the axial direction does not easily escape.

That is, ordinarily, the force applied to the fixing belt in the axial direction in the case where the fixing belt wobbles and deviates on the heat roller is smaller than the force applied to the fixing belt in the axial direction in the case where the fixing belt wobbles and deviates on the fixing roller. For this reason, normally, the fixing belt tends to more easily wobble and deviate on the heat roller, compared to the case where the fixing belt wobbles and deviates on the fixing roller.

In the fixing apparatus 12 according to the first embodiment, the friction coefficient of the surface of the heat roller 33 is smaller than the friction coefficient of the surface of the fixing roller 31, as is the case with general fixing apparatuses. From such a viewpoint, the regulation belts 38 are wound around at least the heat roller 33 in the first embodiment.

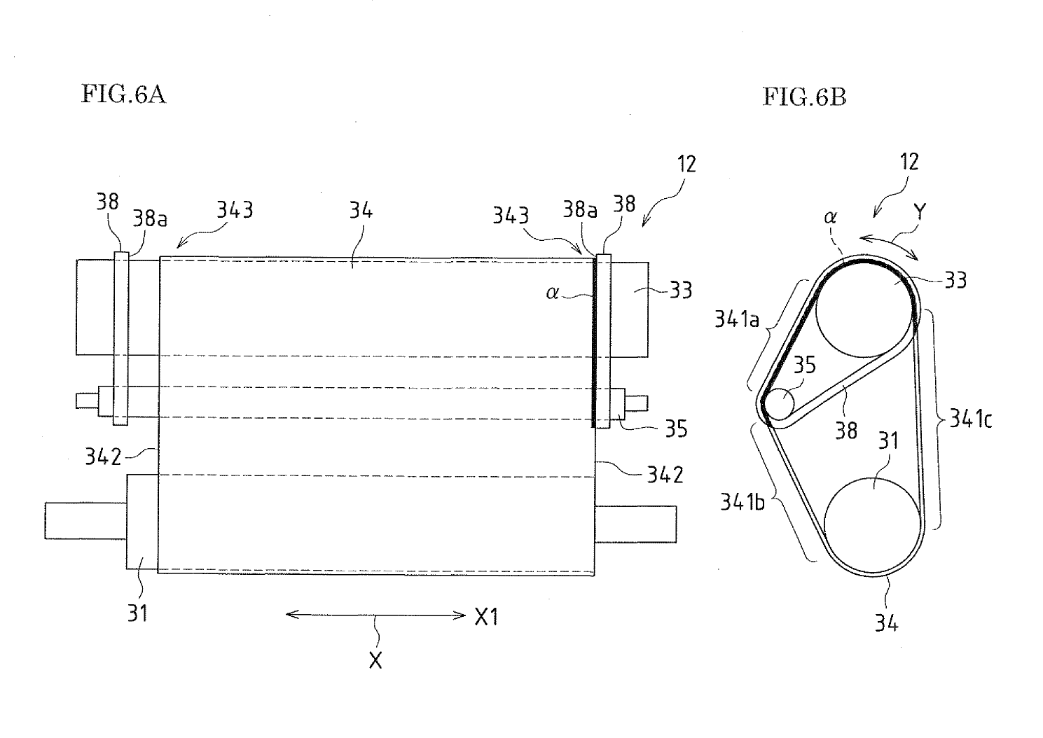

FIGS. 6A and 6B are diagrams illustrating an operation of the regulation belts 38 regulating wobbling and deviation of the fixing belt 34 in the fixing apparatus 12 according to the first embodiment. FIGS. 6A and 6B are a plan view and a lateral view that each show a state in which wobbling and deviation of the fixing belt 34 is occurring. Note that the pressure roller 32 is omitted in FIGS. 6A and 6B.

In the fixing apparatus 12, if the fixing belt 34 that is wound around a plurality of rollers (here, the fixing roller 31, the heat roller 33, and the tension roller 35) moves in the axial direction X (rightward direction X1 in the example in the figure) due to the occurrence of wobbling and deviation in accordance with the rotation of the rollers 31, 33 and 35, which is as shown in FIGS. 6A and 6B, the fixing belt 34 comes into contact with the regulation belt 38, and thereby the movement thereof in the axial direction X (rightward direction X1 in the example in the figure) is regulated by the regulation belt 38.

Here, since the regulation belts 38 are wound around at least one (here, both sides) of both sides in the axial direction X of at least one roller (here, the heat roller 33 and the tension roller 35) among the fixing roller 31, the heat roller 33, and the tension roller 35, a structure in which the regulation belts 38 are wound around can be simplified, compared to a conventional structure. Moreover, movement (wobbling and deviation) of the fixing belt 34 in the axial direction X can be regulated by the regulation belts 38, and furthermore the contact area (see the filled-in area α in the figures) in the circumferential direction Y in which the fixing belt 34 can be in contact with the regulation belts 38 can be increased. Thereby, it is possible to avoid concentration of pressure on a part of the fixing belt 34 in the contact area α, and disperse pressure applied to the contact area α. Accordingly, damage to edge portions 343 (in particular, the edge faces 342) in the axial direction X of the fixing belt 34 can be suppressed.

Further, in the first embodiment, the regulation belts 38 are wound along at least a part of the unwound areas 341a, 341b, and 341c of the fixing belt 34 (here, the first unwound area 341a) and furthermore in the circumferential direction (the winding direction) Y. Consequently, the contact area α in which the fixing belt 34 can be in contact with the regulation belt 38 can be further increased, and pressure applied to a part of the fixing belt 34 in the contact area α can thereby be further dispersed, and thus damage to the edge portions 343 (in particular, the edge faces 342) of the fixing belt 34 can be suppressed by that extent.

Also, in the first embodiment, the endless regulation belts 38 are wound around at least two rollers (here, the heat roller 33 and the tension roller 35) among the fixing roller 31, the heat roller 33, and the tension roller 35, and thus it is not necessary to separately provide members around which the regulation belts 38 are to be wound, and the structure can be further simplified. Moreover, the contact area α in which the fixing belt 34 can be in contact with the regulation belt 38 can be further increased between at least the two rollers 33 and 35. Thereby, pressure applied to a part of the fixing belt 34 in the contact area α can be further dispersed, and thus damage to the edge portions 343 (in particular, the edge faces 342) of the fixing belt 34 can be suppressed by that extent.

Further, in the first embodiment, the regulation belts 38 are caused to revolve following the rotation of the rollers 33 and 35 around which the regulation belts 38 are wound, and thereby the regulation belts 38 and the fixing belt 34 can move at the same speed without separately providing a driving source of the regulation belts 38. Accordingly, with a simple configuration, rubbing in the contact area α in which the fixing belt 34 can be in contact with the regulation belt 38 can be suppressed, and thereby damage to the edge portions 343 (in particular, the edge faces 342) of the fixing belt 34 due to that rubbing can be effectively prevented.

Further, in the first embodiment, the direction of each of the edge faces 38a of the regulation belts 38 conforms to the direction in which the contact area α is increased, and here, the direction of each of the edge faces 38a of the regulation belts 38 and the direction of each of the edge faces 342 of the fixing belt 34 that are opposed to the edge faces 38a of the regulation belts 38 are made parallel or substantially parallel to each other. Thereby, the contact area α in which the fixing belt 34 can be in contact with the regulation belts 38 can be reliably increased, and pressure applied to a part of the fixing belt 34 in the contact area α can be more stably dispersed by that extent.

Further, as in the first embodiment, the regulation belts 38 are wound around at least the heat roller 33 (here, the heat roller 33 whose surface has a smaller friction coefficient than the friction coefficient of the surface of the fixing roller 31), and thus damage to the edge portions 343 (in particular, the edge faces 342) of the fixing belt 34 can be suppressed while reliably regulating wobbling and deviation of the fixing belt 34 on the heat roller 33, on which the fixing belt 34 tends to easily move in the axial direction X.

Note that although the regulation belts 38 are wound around the heat roller 33 and the tension roller 35 among the fixing roller 31, the heat roller 33, and the tension roller 35 in the first embodiment, the regulation belts 38 may be wound around other rollers.

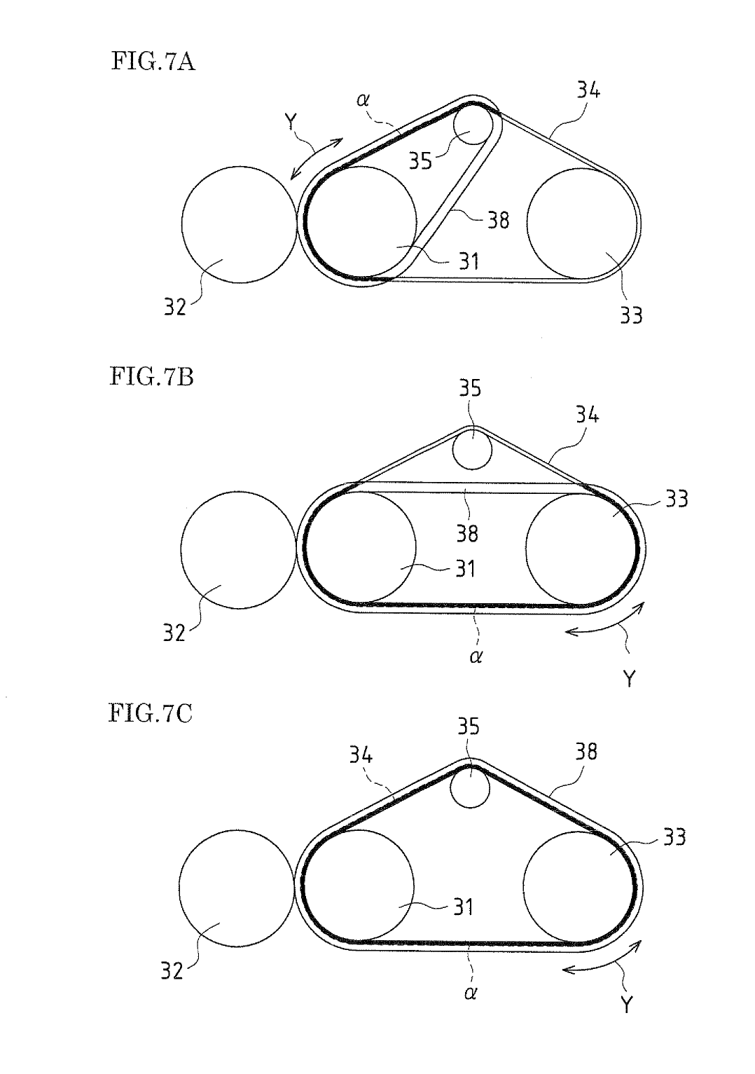

FIGS. 7A to 7C are lateral views showing other examples in which the regulation belts 38 are wound around at least one roller among the fixing roller 31, the heat roller 33, and the tension roller 35 in the first embodiment.

As shown in FIGS. 7A to 7C, the regulation belts 38 may be wound around the fixing roller 31 and the tension roller 35 (see FIG. 7A), or may be wound around the fixing roller 31 and the heat roller 33 (see FIG. 7B). Further, from a viewpoint of maximizing the contact area α in which the fixing belt 34 can be in contact with the regulation belt 38, it is preferable that the regulation belts 38 are wound around all the plurality of rollers 31, 33, and 35 (here, the fixing roller 31, the heat roller 33, and the tension roller 35) around which the fixing belt 34 is wound (see FIG. 7C).

Further, although the rollers around which the fixing belt 34 is wound are the fixing roller 31, the heat roller 33, and the tension roller 35 in the first embodiment, the fixing belt 34 may be wound around only the fixing roller 31 and the heat roller 33 after removing the tension roller 35.

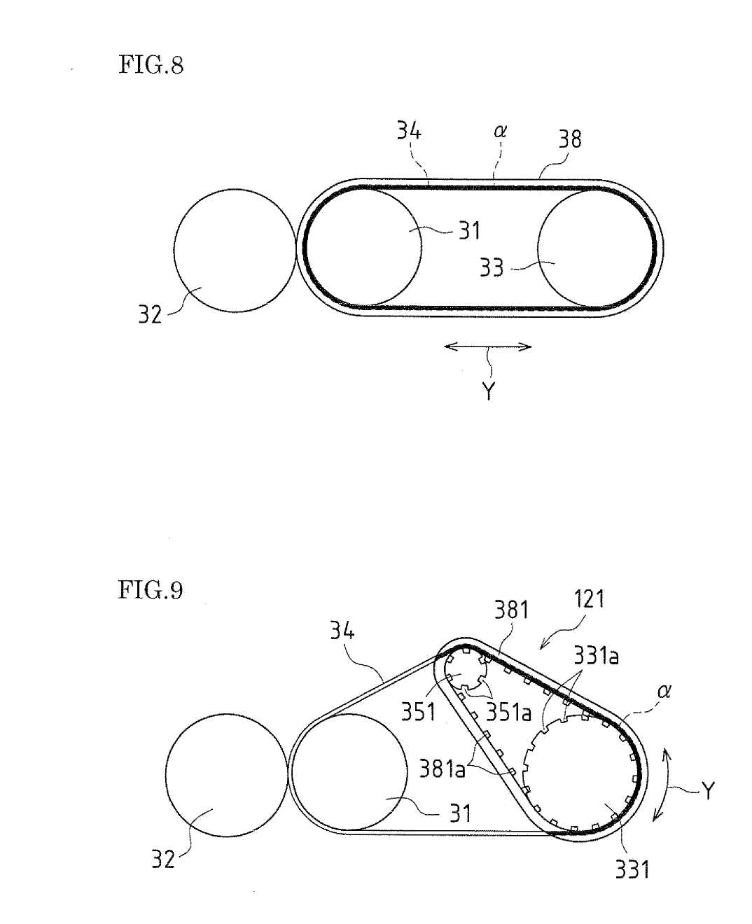

FIG. 8 is a lateral view showing a state in which the regulation belts 38 are wound around in the case where the fixing belt 34 is wound around the fixing roller 31 and the heat roller 33 in the first embodiment.

In this case, the regulation belts 38 are wound around the fixing roller 31 and the heat roller 33 around which the fixing belt 34 is wound, as shown in FIG. 8.

### Second Embodiment

FIG. 9 is a lateral view illustrating a fixing apparatus 121 according to a second embodiment. Note that in the second embodiment shown in FIG. 9, the same reference numerals are given to the same constituent elements as those in the first embodiment, and a description thereof is omitted. The same applies to third to seventh embodiments described later.

In the second embodiment, regulation belts 381 and rollers 331 and 351 around which the regulation belts 381 are wound are engaged with each other using recessions and projections.

Specifically, the regulation belts 381 are obtained by providing the regulation belts 38 in the first embodiment with a plurality of projecting portions (for example, a plurality of projecting line portions in the axial direction X) 381a with equally-spaced intervals in the circumferential direction Y on the inner circumferential face. Other than this configuration, the regulation belts 381 are assumed to have the same configuration as that of the regulation belts 38. Note that the plurality of projecting portions 381a may be depressed portions (for example, a plurality of depressed line portions in the axial direction X).

The heat roller 331 is obtained by providing the heat roller 33 in the first embodiment with a plurality of depressed portions (for example, a plurality of depressed line portions in the axial direction X) 331a on at least a part of the outer circumferential face around which the regulation belts 381 are wound, in the circumferential direction Y with equally-spaced intervals (corresponding to the projecting portions 381a of the regulation belts 381). Other than this configuration, the heat roller 331 is assumed to have the same configuration as that of the heat roller 33. Note that the plurality of depressed portions 331a may be projecting portions (for example, a plurality of projecting line portions in the axial direction X).

Similarly, the tension roller 351 is also obtained by providing the tension roller 35 in the first embodiment with a plurality of depressed portions (for example, a plurality of depressed line portions in the axial direction X) 351a on at least a part of the outer circumferential face around which the regulation belts 381 are wound, in the circumferential direction Y with equally-spaced intervals (corresponding to the projecting portions 381a of the regulation belts 381). Other than this configuration, the tension roller 351 is assumed to have the same configuration as that of the tension roller 35. Note that the plurality of depressed portions 351a may be projecting portions (for example, a plurality of projecting line portions in the axial direction X).

In the second embodiment, the regulation belts 381, and the rollers 331 and 351 around which the regulation belts 381 are wound are engaged with each other using recessions and projections, thereby preventing the regulation belts 381 and the fixing belt 34 from shifting, and thus these belts 381 and 34 can be reliably moved at the same speed. Accordingly, rubbing in the contact area α in which the fixing belt 34 can be in contact with the regulation belt 381 can be reliably suppressed, and thereby damage to the edge portions 343 (in particular, the edge faces 342) of the fixing belt 34 due to that rubbing can be effectively prevented by that extent.

Note that a configuration may be adopted in which a rack is formed on the inner circumferential face of each of the regulation belts 381, and gears are formed on part of the outer circumferential face of each of the rollers 331 and 351 around which the regulation belts 381 are wound, the part having the regulation belts 381 wound around, and the racks and the gears are engaged with each other.

### Third Embodiment

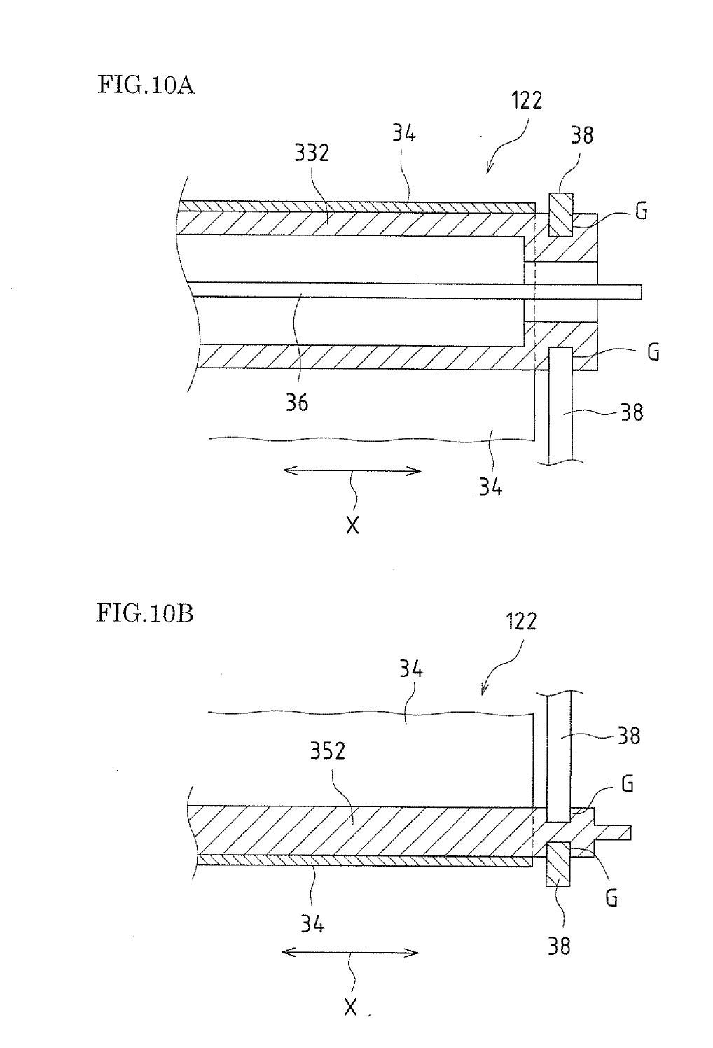

FIGS. 10A and 10B are cross-sectional views illustrating a fixing apparatus 122 according to the third embodiment. FIG. 10A shows a guide groove G provided in a heat roller 332, and FIG. 10B shows a guide groove G provided in a tension roller 352.

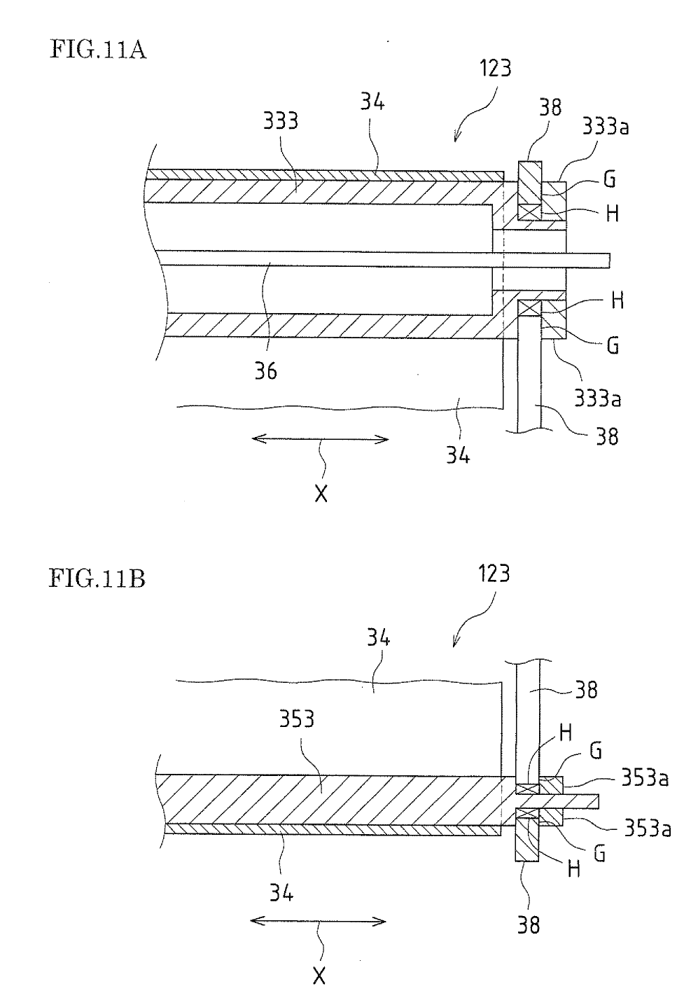

In the third embodiment, at least one of the rollers 332 and 352 (here, both the rollers) around which the regulation belts 38 are wound has the guide grooves G in which the regulation belts 38 are disposed formed over the whole circumference. Note that since the configuration of both sides of the heat roller 332 and the tension roller 352 is the same, FIGS. 10A and 10B show the configuration of one side, and the configuration of the other side is omitted in the figures. The same also applies to the fourth to seventh embodiments shown in FIGS. 11A to 14B described later.

Other than this configuration, the heat roller 332 and the tension roller 352 are assumed to have the same configuration as that of the heat roller 33 and the tension roller 35.

Specifically, the thickness of each of the regulation belts 38 is greater than the depth of each of the guide grooves G. Further, the thickness of a part of each of the regulation belts 38 that projects from the outer circumferential faces of the rollers 332 and 352 is greater than the thickness of the fixing belt 34.

Further, the width of each of the guide grooves G is greater than the width of each of the regulation belts 38. Here, the guide grooves G are guide grooves that each have a width about the same as the width of each of the regulation belts 38 (a width slightly wider than the width thereof in the axial direction X).

In the third embodiment, the regulation belts 38 are put into the guide grooves G that are formed over the whole circumference of at least one of the rollers 332 and 352 (here, both the rollers) around which the regulation belts 38 are wound, and thereby the movement (wobbling and deviation) of the regulation belts 38 themselves in the axial direction X can be regulated.

Note that the third embodiment may be achieved in combination with the configuration of the second embodiment shown in FIG. 9.

### Fourth Embodiment

FIGS. 11A and 11B are cross-sectional views illustrating a fixing apparatus 123 according to the fourth embodiment. FIG. 11A shows a sliding bearing H with which a heat roller 333 is provided, and FIG. 11B shows a sliding bearing H with which a tension roller 353 is provided.

In the fourth embodiment, the regulation belts 38 are configured to freely revolve with respect to the rollers 333 and 353 around which the regulation belts 38 are wound.

Specifically, the heat roller 333 is obtained by providing the heat roller 33 in the first embodiment with the sliding bearings H on at least part of the outer circumferential face around which the regulation belts 38 are wound. Here, the diameter of each of the both ends in the axial direction X of the heat roller 333 is formed so as to be smaller such that the sliding bearings H can be fitted thereon. The heat roller 333 is provided with stopper members 333a for preventing the sliding bearings H that have been fitted thereon from slipping outward in the axial direction X. Other than this configuration, the heat roller 333 is assumed to have the same configuration as that of the heat roller 33.

Similarly, the tension roller 353 is also obtained by providing the tension roller 35 in the first embodiment with the sliding bearings H on at least part of the outer circumferential face around which the regulation belts 38 are wound. Here, the diameter of each of both ends in the axial direction X of the tension roller 353 is formed so as to be smaller such that the sliding bearings H can be fitted thereon. The tension roller 353 is provided with stopper members 353a for preventing the sliding bearings H that have been fitted thereon from slipping outward in the axial direction X. Other than this configuration, the tension roller 353 is assumed to have the same configuration as that of the tension roller 35.

The sliding bearings H with which the heat roller 333 and the tension roller 353 are provided are used for allowing the regulation belts 38 to be wound around so as to be freely movable relatively in the circumferential direction Y with respect to the heat roller 333 and the tension roller 353. Typical examples of the sliding bearings H include a plain bearing and a rolling bearing (ball bearing).

In the fourth embodiment, the regulation belts 38 are allowed to freely revolve with respect to the rollers 333 and 353 around which the regulation belts 38 are wound, and thus do not revolve following the rotation of the rollers 333 and 353. Thereby, it is possible to reduce the rotational load of the rollers 333 and 353.

Note that the fourth embodiment is achieved in combination with the configuration of the third embodiment shown in FIG. 10. Specifically, the outer diameter of each of the sliding bearings H is smaller than the outer diameter of the heat roller 333 and the outer diameter of the stopper member 333a. This enables the guide grooves G to be formed in the heat roller 333. Further, the outer diameter of each of the sliding bearings H is smaller than the outer diameter of the tension roller 353 and the outer diameter of the stopper member 353a. This enables the guide grooves G to be formed in the tension roller 353. As described above, operation effects of the third embodiment described above can also be obtained in the fourth embodiment.

### Fifth Embodiment

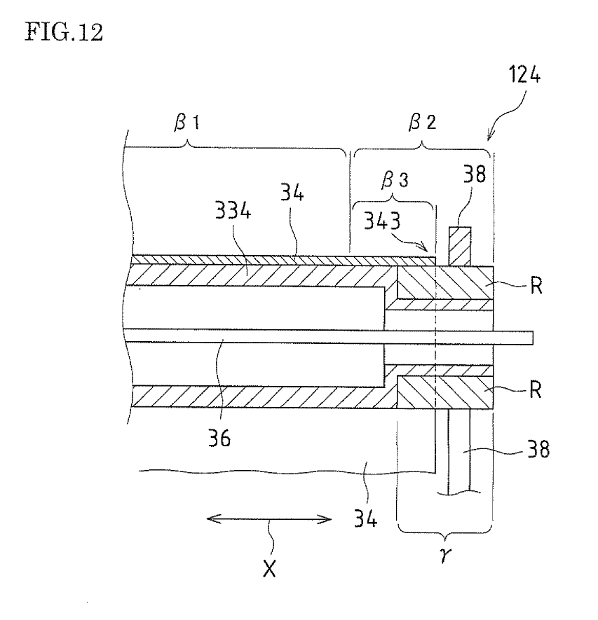

FIG. 12 is a cross-sectional view that illustrates a fixing apparatus 124 according to the fifth embodiment, and shows an insulating member R provided on a heat roller 334.

A fixing belt is ordinarily made of belt material that becomes softer in a high temperature state compared to a low temperature state, and thus the edge portions 343 of the fixing belt 34 become easily affected by the external force. Accordingly, if wobbling and deviation of the fixing belt 34 occurs in a high temperature state, the edge portions 343 of the fixing belt 34 tend to easily curl up or deform and be damaged due to the regulation belts 38.

From such a viewpoint, the fixing apparatus 124 according to the fifth embodiment has the following configuration. Specifically, each of the rollers 31, 334, and 35 around which the fixing belt 34 is wound has a fixing area β1 where the unfixed toner T on the recording sheet P is to be fixed, and non-fixing areas β2 on both sides in the axial direction X and outside the fixing area β1.

The fixing belt 34 is wound around the fixing area β1 of each of the rollers 31, 334, and 35 around which the fixing belt 34 is wound, and outer areas β3 outside the fixing area β1 in the axial direction X. Note that the width of each of the outer areas β3 in the axial direction X is smaller than the width of each of the non-fixing areas β2 in the axial direction X.

The insulating members R are provided on at least one roller (here, the heat roller 334) among the rollers 31, 334, and 35 around which the fixing belt 34 is wound.

The insulating members R are provided, over the whole circumference, on outer edge area portions γ of at least one roller (here, the heat roller 334) that include at least a part of the outer areas β3 in the axial direction X, in the non-fixing areas β2 that are on the end portions (here, both end sides) on the sides around which the regulation belts 38 are wound in the axial direction X. It is preferable that the insulating members R are provided on at least the heat roller 334.

Note that here, the outer edge area portions γ on which the insulating members R are provided are assumed to be areas from a point within the outer areas β3 in the axial direction X to the outer end of the non-fixing areas β2. However, the present invention is not limited thereto, and the outer edge area portions γ may include the entire outer areas β3. Further, if the entire outer areas β3 or part of the outer areas β3 are included, the outer edge area portions γ do not need to extend up to the outer end of the non-fixing areas β2.

Specifically, the insulating members R are formed cylindrically, and the heat roller 334 is obtained by forming the heat roller 33 in the first embodiment such that the diameter of each of the outer edge area portions γ on both sides is small enough to allow the insulating members R to be fitted thereon. The insulating members R are fitted on the outer edge area portions γ of the heat roller 334. Other than this configuration, the heat roller 334 is assumed to have the same configuration as that of the heat roller 33.

Note that the outer diameter of the heat roller 334 and the outer diameter of each of the insulating members R have the same length, and the regulation belts 38 are wound around the areas of the insulating members R around which the fixing belt 34 is not wound, in the axial direction X.

Examples of the material of the insulating members R include a PPS (polyphenylene sulfide) resin and a PI (polyimide) resin.

In the fifth embodiment, in order to lower the temperature of the edge portions 343 of the fixing belt 34, the insulating members R are provided, over the whole circumference, on the outer edge area portions γ of at least one roller (here, the heat roller 334) among the rollers 31, 334, and 35 around which the fixing belt 34 is wound, and thereby it is possible to suppress heat that is transferred to the edge portions 343 of the fixing belt 34. Accordingly, the temperatures of the edge portions 343 of the fixing belt 34 can be lowered, and ultimately it is possible to suppress damage to the edge portions 343 (in particular, the edge faces 342) of the fixing belt 34 that may be caused when the fixing belt 34 wobbles and deviates.

Note that a combination of at least two of the configuration of the fifth embodiment and the configurations of the second to fifth embodiments shown in FIGS. 9 to 12 may be applied. The configuration achieved with use of a combination of this fifth embodiment and the third embodiment is shown in the following sixth embodiment.

### Sixth Embodiment

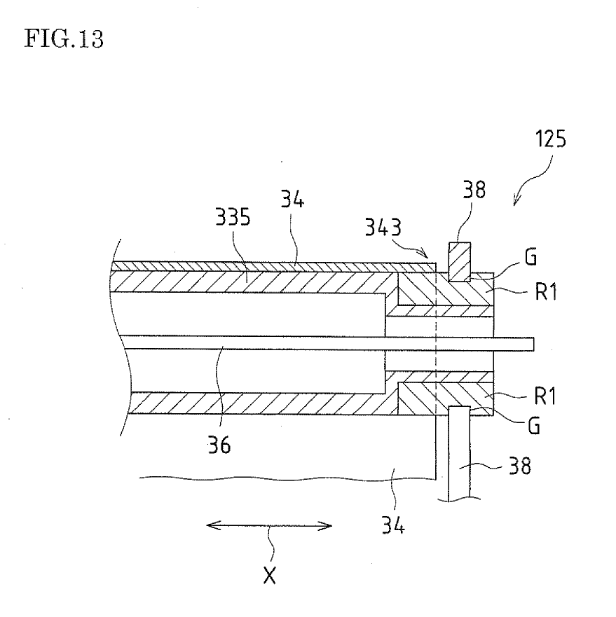

FIG. 13 is a cross-sectional view illustrating a fixing apparatus 125 according to the sixth embodiment.

The configuration of the sixth embodiment is achieved with use of a combination of the configuration of the fifth embodiment in which the insulating members R are provided and the configuration of the third embodiment in which the guide grooves G are provided.

In the fixing apparatus 125 according to the sixth embodiment, the guide grooves G in which the regulation belts 38 are disposed are formed in insulating members R1 provided on a heat roller 335, in the outer circumferential direction.

Specifically, the thickness of each of the regulation belts 38 is greater than the depth of each of the guide grooves G. Further, the thickness of a part of each of the regulation belts 38 that projects from the outer circumferential face of the roller 335 is greater than the thickness of the fixing belt 34.

Further, the width of each of the guide grooves G is greater than the width of each of the regulation belts 38. Here, the guide grooves G are guide grooves that each have a width about the same as the width of each of the regulation belts 38 (a width slightly wider than the width thereof in the axial direction X).

In the sixth embodiment, operation effects of both the third and fifth embodiments can be achieved.

### Seventh Embodiment

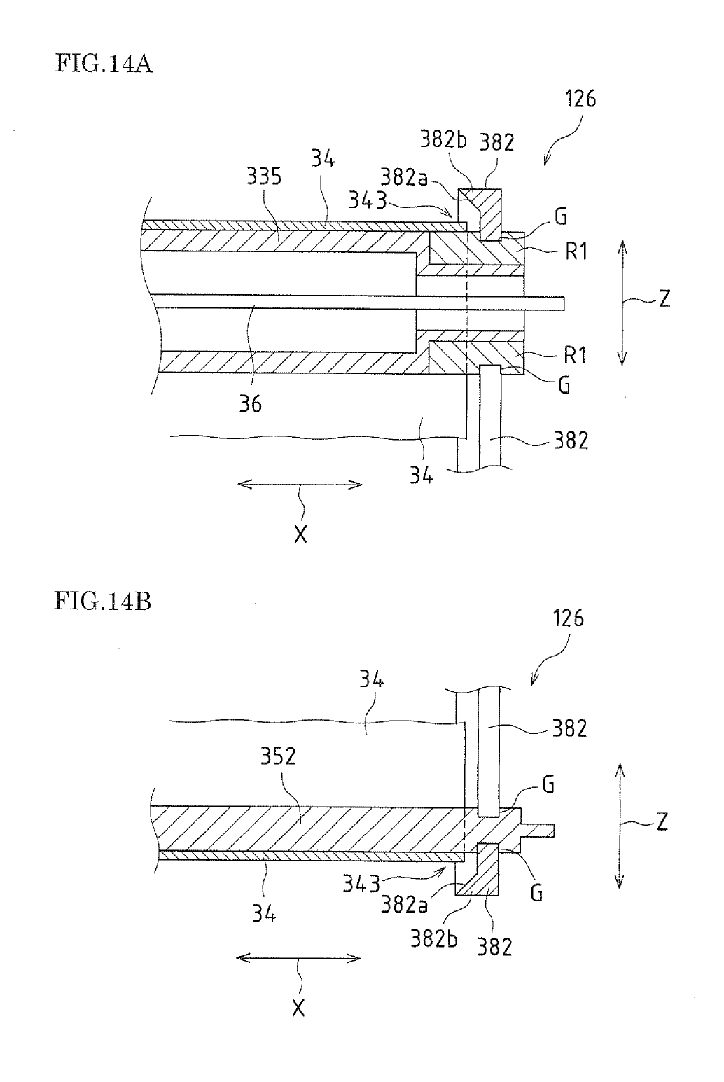

FIGS. 14A and 14B are cross-sectional views illustrating a fixing apparatus 126 according to the seventh embodiment. FIG. 14A shows a regulation belt 382 wound around the heat roller 335, and FIG. 14B shows the regulation belt 382 wound around the tension roller 352.

With the configuration of the regulation belt 38 in the first embodiment and the third to sixth embodiments and the configuration of the regulation belt 381 in the second embodiment, when regulating wobbling and deviation of the fixing belt 34, if the force applied to the fixing belt 34 in the axial direction X is great, the fixing belt 34 may climb over the regulation belt 38 or 381, and/or the fixing belt 34 may curl up.

In order to prevent this, the fixing apparatus 126 according to the seventh embodiment has the following configuration. Specifically, the regulation belts 382 are provided with protruding portions 382b that protrude toward the fixing belt 34. The protruding portions 382b are positioned at outer positions in a belt thickness direction (the direction of arrow Z in the figures) relative to the fixing belt 34.

Here, at least a part of each of edge faces 382a of the regulation belts 382 in the belt thickness direction Z (here, a part from a point in the belt thickness direction Z to the outer edge) is assumed to have an inclined shape so as to face toward the fixing belt 34, the edge faces being opposed to the fixing belt 34. Specifically, the width of each of the regulation belts 382 becomes gradually greater to the outside in the diameter direction of the rollers 335 and 352.

FIGS. 14A and 14B show examples in which the regulation belts 382 are wound around the heat roller 335 in the sixth embodiment shown in FIG. 13 and the tension roller 352.

In the seventh embodiment, each of the regulation belts 382 is provided with the protruding portion 382b, and thus it is possible to prevent the fixing belt 34 from easily climbing over the regulation belt 382, and/or it is possible to prevent the fixing belt 34 from easily curling up.

In addition, here, at least a part of the edge faces 382a of the regulation belts 382 has an inclined shape so as to face toward the fixing belt 34, the edge faces being opposed to the fixing belt 34 in the belt thickness direction Z, and thus the edge portions 343 of the fixing belt 34 that reach the edge faces 382a of the regulation belts 382 can be caused to slide toward the roller 335 or 352 and to return toward the center in the axial direction X, by the inclined edge faces 382a of the regulation belts 382.

Note that a combination of at least two of the configuration of the seventh embodiment and the configurations of the second embodiment to the sixth embodiment shown in FIGS. 9 to 13 may be applied.

The present invention may be embodied in various other forms without departing from the spirit or essential characteristics thereof. The embodiments disclosed herein are to be considered in all respects as illustrative and not limiting. The scope of the invention is indicated by the appended claims rather than by the foregoing description. All variations and modifications falling within the equivalency range of the appended claims are intended to be embraced therein.

1. A fixing apparatus, comprising:
a plurality of rollers that includes a fixing roller;
an endless fixing belt that is wound around the plurality of rollers; and
a regulation belt that is wound around at least one of both sides in an axial direction of at least one roller among the plurality of rollers, and regulates movement of the fixing belt in the axial direction.

2. The fixing apparatus according to claim 1,
wherein the regulation belt is provided along at least a part of an unwound area of the fixing belt where the fixing belt is separated from the plurality of rollers.

3. The fixing apparatus according to claim 1,
wherein the regulation belt is an endless belt, and is wound around at least two rollers among the plurality of rollers.

4. The fixing apparatus according to claim 1,
wherein the regulation belt is configured to follow rotation of the at least one roller around which the regulation belt is wound.

5. The fixing apparatus according to claim 1,
wherein the regulation belt is freely movable in a circumferential direction with respect to the at least one roller around which the regulation belt is wound.

6. The fixing apparatus according to claim 4,
wherein the regulation belt and the at least one roller around which the regulation belt is wound are engaged with each other using recessions and projections.

7. The fixing apparatus according to claim 1,
wherein a guide groove in which the regulation belt is disposed is formed, over the whole circumference, in at least one roller of the at least one roller around which the regulation belt is wound.

8. The fixing apparatus according to claim 1,
wherein the rollers around which the fixing belt is wound have a fixing area where unfixed toner on a recording sheet is to be fixed and a non-fixing area outside the fixing area in the axial direction,
the fixing belt is wound around the fixing area of the rollers around which the fixing belt is wound and an outer area outside the fixing area in the axial direction, and
an insulating member is provided, over the whole circumference, on an outer edge area portion that includes at least a part of the outer area in the axial direction in the non-fixing area of at least one roller among the rollers around which the fixing belt is wound.

9. The fixing apparatus according to claim 1,
wherein a protruding portion that protrudes toward the fixing belt is provided on the regulation belt.

10. The fixing apparatus according to claim 9,
wherein at least a part of an edge face of the regulation belt in a belt thickness direction has a shape inclined toward the fixing belt, the edge face being opposed to the fixing belt.

11. The fixing apparatus according to claim 1,
wherein a part of an edge face of the regulation belt in a circumferential direction is a contact area where the fixing belt can be in contact with the regulation belt while the fixing belt rotates, the edge face being opposed to the fixing belt, and the regulation belt is wound so that the contact area is larger than the other area.

12. The fixing apparatus according to claim 1,
wherein among the plurality of rollers, at least one of the rollers other than the fixing roller is a heat roller, and
the regulation belt is wound around at least the heat roller.

13. An image forming apparatus comprising the fixing apparatus according to claim 1.
